(19) United States
(12) Patent Application Publication
(10) Pub. No.: US 2005/0096782 A1
(43) Pub. Date: May 5, 2005

(54) Automated sorter system and method thereof

(76) Inventors: T-Chun Chen, Kaohsiung City (TW); Hsien Jung Hsu, Taipei City (TW); Tse-An Chou, Taichung City (TW); Ming Wang, Jhonghe City (TW); Larry Jann, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/696,937

(22) Filed: Oct. 30, 2003

(51) Int. Cl. G06F 7/00

(52) U.S. Cl. 700/224

(57) ABSTRACT

A system and method for automated sorter operations including a storage device and a sorting module. The storage device stores multiple process records, each record including an identity and a current status. The sorting module receives a wafer lot identity and acquires the current status from the process record accordingly. The sorting module issues a first status setting instruction to a manufacturing execution system (MES) to release the wafer lot, issues a flow instruction with sorting recipes directing the MES to perform a sorter operation, and issues a second status setting Instruction to the MES to hold or bank the wafer lot.

### BACKGROUND

The present invention relates to production control technology, and more particularly, to a method and system of performing an automated sorter operation on wafer lots.

A conventional semiconductor factory typically includes multiple fabrication areas or bays interconnected by transportation rails or conveyor belts. Each bay generally includes the requisite fabrication tools to process semiconductor wafers for a particular purpose, such as photolithography, chemical-mechanical polishing, or chemical vapor deposition. The wafers are typically stored in containers, such as cassettes, each of which holds up to 25 wafers. The cassettes are then loaded in carriers, such as standard mechanical interfaces (SMIFs) or front opening unified pods (FOUPs) for transport throughout the factory.

A wafer sorter is a processing tool, used at various points during the semiconductor manufacturing process to perform a number of different functions. One of the functions is to transfer one or more wafers between the various cassettes positioned within the wafer sorter. The wafers can be transferred between the cassettes in the same order or reordered as desired. Another function is to map the location of wafers within a cassette, and to detect incorrect positioning of wafers within a cassette.

A wafer sorter operation can be preset to perform necessary carrier exchange from a front-end to a specified back-end carrier. Alternatively, wafer sorter operations such as exchanging a dirty carrier with a clean carrier can be executed dynamically. Several wafers from different carriers can be combined into one to save space, and increase dispatching efficiency. Additionally, wafers from one carrier can be separated into more than one carrier.

A typical semiconductor manufacturing facility processes thousands of wafers at any given time. The wafers are typically divided into lots that undergo different processing sequences. Wafer lots are typically divided into three categories during the manufacturing process: normal, on hold, and in bank during the manufacturing process. Normal wafer lots are ready to undergo an operation using a particular tool, while held and banked lots are stocked and unable to undergo any operation. Thus, held and banked wafer lots are unable to undergo a sorter operation via manufacturing execution system (MES), carrier management system or monitor automation system.

To address the above limitation, an operator manually sorts held or banked wafer lots and carries the lots to a wafer sorter loadport. The wafer sorter is then switched to manual mode, and a relevant recipe for performing a particular sorter operation is input through the panel. The wafer lots are subsequently returned to their original location. Although functional, the conventional method has several drawbacks including heavy reliance on human labor, thus, hindering the ultimate goal of full automation. It is noted that manual operations cannot be tracked by computer and held or banked wafer lots may be lost due to operator error. Additionally, forced manual interruption of a wafer sorter may reduce its utility.

In view of these limitations, a need exists for a system and method of automated sorter operation that reduces lot handling cycle time and improves efficiency.

### SUMMARY

It is therefore an object of the present invention to provide a system and method of automated sorter operation to reduce lot handling cycle time and improve wafer sorter efficiency.

According to the embodiment of the invention, the system includes a wafer sorter, a transport system, and a sorting apparatus. The wafer sorter includes a computer arrangement coupled to a manufacturing execution system (MES). The computer arrangement controls the internal functions of the machine and can process instructions from the MES when changes must be made during processing of current wafer lots. It also has recipe functionality such that wafers are grouped in response to instructions from the internal program or from the sorting apparatus. The wafer sorter can be programmed to manipulate multiple carrier sets for large set slot mapping, exchange, splits, and combinations. The transport system moves carriers containing wafer lots from one site to the wafer sorter based on instructions from the MES during the manufacturing process.

The sorting apparatus includes a central processing unit (CPu), a memory, and a storage device. The CPU, controlled by instructions received from the memory and from an operator through the input device, directs automated sorter operations. The storage device stores multiple process records and each preferably includes a current status and hold/bank information. The memory preferably includes a sorting module and stored routines for wafer sorting operations on held or banked wafer lots.

The sorting module first receives a wafer lot identity, and next, acquires the current status and corresponding hold/bank information from the process record. The sorting module subsequently stores the wafer lot identity, current status, and corresponding hold/bank information into a temporary file or table. The wafer lot is determined to be on hold, in a production or in a non-production bank according to the current status. The sorting module issues a status setting instruction corresponding to the current status to the MES to release it. The MES follows standard procedural steps to release the wafer lot.

Thereafter, the sorting module creates a floating process flow and assigns the wafer lot to the flow by issuing instructions to the MES. The floating process flow is created during a predetermined process routing to perform dynamic sorter operations, such as slot mapping, carriers exchange, wafer lot combination, or splits. Relevant sorting recipe data corresponding to the sorter operation is also provided in the floating process window. The MES applies the tool dispatch rule according to specific sorter constraints to determine if the wafer sorter is performing the specified sorter operation. Accordingly, the MES starts the transport system to transport the wafer lot to the wafer sorter, and the wafer sorter to perform the sorter operation based on automated sorting recipe instructions.

When sorting is complete, the sorting module acquires the current status and corresponding hold/bank information of the wafer lot from the temporary file or table. The sorting module then issues a status setting instruction corresponding to the current status to the MES to hold or bank the wafer lot. Finally, the sorting module removes the temporary file or table from the storage device.

### BRIEF DESCRIPTION OF THE DRAWINGS

The aforementioned objects, features and advantages of this invention will become apparent by ref erring to the following detailed description of the preferred embodiment with reference to the accompanying drawings, wherein:

FIG. 1 is a diagram of the architecture of the system for automated sorter operation according to the present invention;

FIG. 2 is a flowchart showing an exemplary wafer lot manufacturing process according to the present invention;

FIG. 3 is a flowchart showing the method of automated sorter operation according to the present invention;

FIG. 4 is a diagram of a storage medium for storing a computer program providing the method of automated sorter operation according to the invention.

### DESCRIPTION

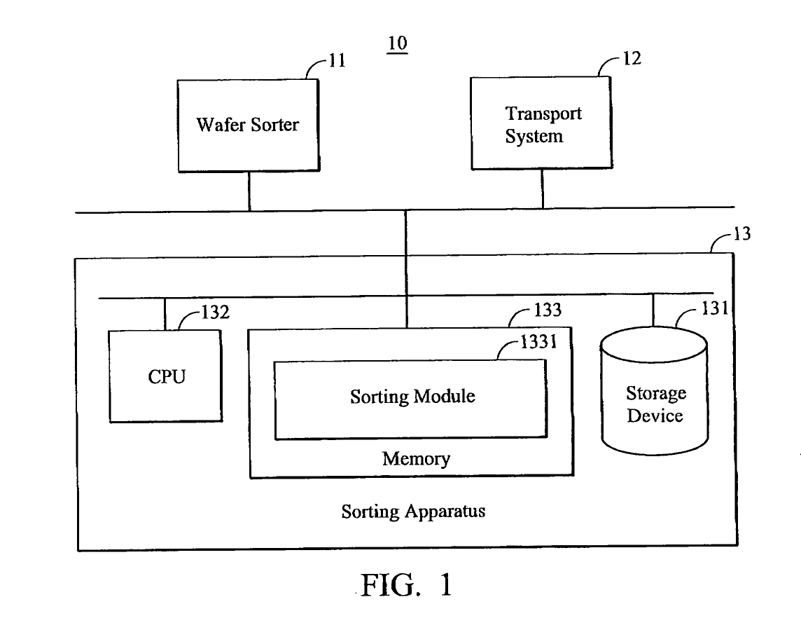

FIG. 1 is a diagram of the architecture of the system for automated sorter operation according to the present invention. The system 10 includes a wafer sorter 11, a transport system 12, and a sorting apparatus 13.

The wafer sorter 11 is located near a bay and sorts wafers in an enclosure. The wafer sorter 11 has a computer arrangement therein coupled to a manufacturing execution system (MES) (not shown). The computer arrangement controls the internal functions of the machine and processes instructions from the MES when changes must be made during processing of current wafer lots. An included recipe function groups wafers in response to instructions from the internal program or from the sorting apparatus 13. Other recipe functions include externally guided recipes and on-demand internal recipes, which can be combined with other system functions including cassette type balancing, cassette cleaning, and empty cassette integration. The wafer is sorter 11 can be programmed to manipulate multiple carrier sets for large set slot mapping, exchange, splits, and combinations.

The transport system 12 moves carriers containing wafer lots from one site to the wafer sorter 11 based on instructions from the MES. Wafer carriers are typically input to the transport system 12 using automated equipment. Automated equipment is also used to remove wafer carriers using the equipment loadport as the exit point, with the transport system 12 and/or removal equipment designed to allow several wafer carriers to accumulate near locations while preventing collisions between adjacent wafer carriers.

The sorting apparatus 13 includes a central processing unit (CPU) 132, a memory 133 and a storage device 131. The CPU 132 is connected by a bus 134 to the memory 133, a communication device (not shown), an input device (not shown), and a display device (not shown) based on Von Neumann architecture. The CPU 132, memory 133, storage device 131, display device, input device, and communication device may be conventionally coupled to a mainframe computer, a mini-computer, a workstation computer, or a personal computer.

The CPU 132, controlled by instructions received from the memory 133 and from an operator through the input device, directs automated sorter operations.

The storage device 131 can be implemented as a database system, a file, or the like, to store multiple process records of wafer lots. The process record preferably includes a current status and hold/bank information. The current status of the process record enables lot tracking to determine if wafer lots are on hold or in bank. If wafer lots are on hold, hold information, such as time, reason, note, operator, department, or others, is recorded. The bank information includes data similar to the hold information. Consistent with the scope and spirit of the invention, additional or different contents may be provided in the hold/bank information. Furthermore, the banked wafer lots are divided into two categories, “production” and “non-production”. Wafer lots in bank at the start or end of an operation are referred to as “production” lots. Conversely, wafer lots in bank between the start and end of an operation are referred to as “non-production” lots.

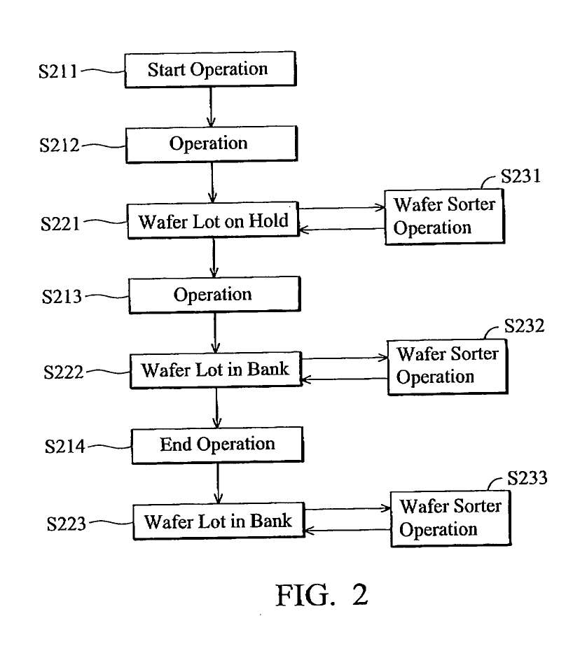

FIG. 2 is a flowchart showing an exemplary wafer lot manufacturing process according to the present invention. The predetermined process includes a start operation S211, operations S212, S213, and an end operation S214. Operations S212 and S213 execute wafer manufacturing tasks with a particular machine if required. In the preferred embodiment, while a wafer lot is in a process routing, in step S221, the wafer lot is held for inspection, and, in step S222, is banked for several hours due to a quality issue. The current status of wafer lot is set to “on hold”, and “in non-production bank” in step S221 and S222 respectively. After step S214, the wafer lot is banked as in step S223, and the current status is recorded to “in production bank”. Conventionally, the wafer lot in step S221, S222, or S223 cannot be processed until it is released. According to this invention, the system 10 is provided to execute wafer sorter operations such as in step S231, S232, and S233 for held or banked wafer lots to reduce lot handling cycle time.

The memory 133 is preferably a random access memory (RAM), but may also include read-only memory (ROM) or flash ROM. The memory 133 preferably includes a sorting module 1331 including routines to perform wafer sorting functions for held or banked wafer lots.

The sorting module 1331 first receives a wafer lot identity, then, acquires the current status and corresponding hold/bank information from the process record. Wafer lot identity may be input by an operator via a user interface, or a computer system, such as a carrier management system, a monitor automation system or others. The sorting module 1331 subsequently stores the wafer lot identity, current status, and corresponding hold/bank information into a temporary file or table. The wafer lot is determined to be on hold, in a production or in a non-production bank according to the current status. If the wafer lot is on hold as in step S221, it is set to “hold release” by issuing a status setting instruction to the MES. Similarly, if the wafer lot is in a non-production bank as in step S222 or a production bank as in step S223, it is sequentially set to “hold release”, “non-production bank out” or “hold release”, “bank move/bank in cancel” respectively by status setting instructions. The MES follows standard procedural steps to release the wafer lot.

Subsequent to release, the sorting module 1331 creates a floating process flow and assigns the wafer lot to the flow by issuing instructions to the MES. The floating process flow is created during a predetermined process routing to perform dynamic sorter operations, such as slot mapping, carriers exchange, wafer lot combination, or splits. Relevant sorting recipe data corresponding to the sorter operation is also provided in the floating process window. The MES applies the tool dispatch rule according to specific sorter constraints to determine if the wafer sorter 11 is performing the specific sorter operation. Accordingly, the MES starts the transport system 12 to transport the wafer lot to the wafer sorter 11, and for sorter operations based on automated sorting recipe instructions.

When sorting is complete, the sorting module 1331 acquires the current status and corresponding hold/bank information of the wafer lot from the temporary file or table. Similarly, if the wafer lot is on hold prior to sorting, the wafer lot is set to “hold lot” by issuing the status setting instruction to the MES. In the same way, if the wafer lot is in a non-production or a production bank, the wafer lot is sequentially set to is “non-production bank in”, “hold lot”, or “bank in/bank move”, “hold lot”. The MES then determines a destination, such as a processing machine or a stocker, for the wafer lot using the tool dispatch rule. The MES starts the transport system 12 to transport the wafer lot to the destination using automated instructions. Finally, the sorting module 1331 removes the temporary file or table from the storage device 131.

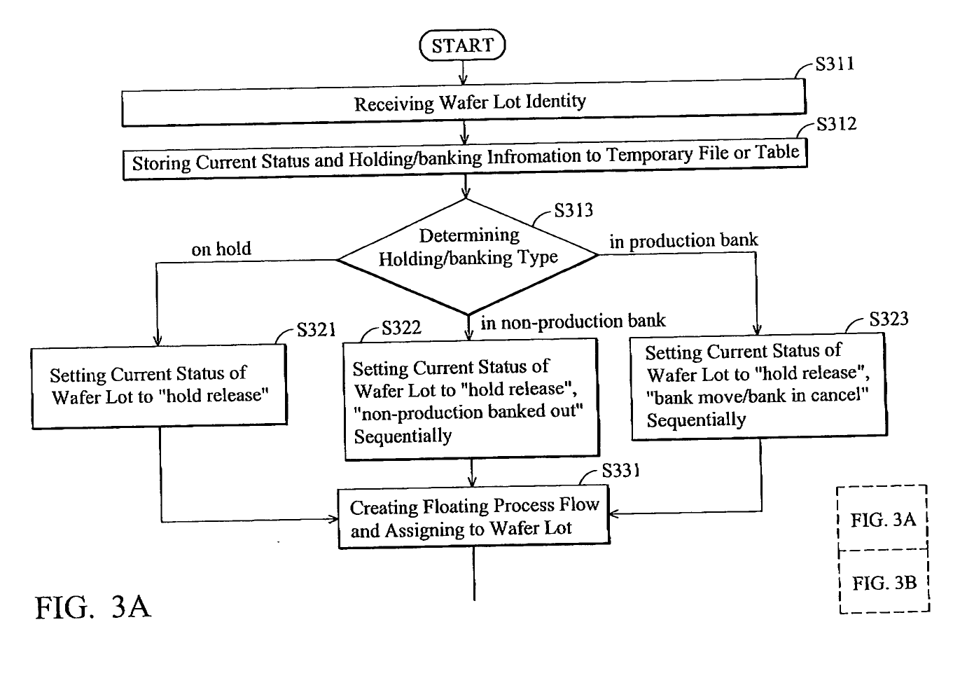

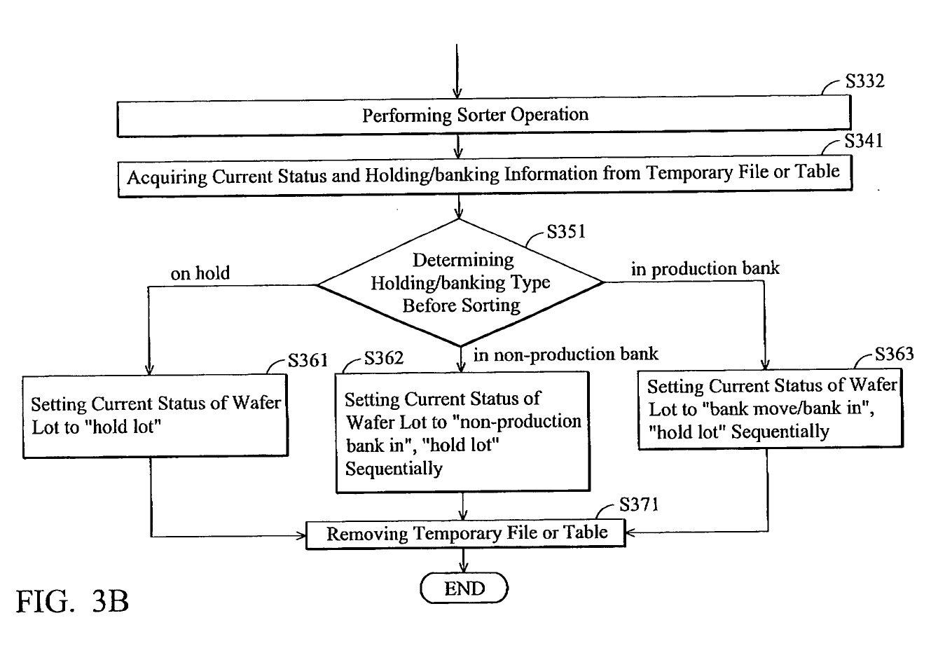

FIG. 3 is a flowchart showing the method of automated sorter operation according to the present invention. The method begins in step S311 by receiving a wafer lot identity. In step S312, current wafer lot status and corresponding hold/bank information is stored in a temporary table or file in storage device 131. The hold/bank type of wafer lot is determined as in step S313 according to the current status. If the wafer lot is on hold, the process goes to step S321 to set the wafer lot to “hold release” by issuing the status setting instructions to the MES. Additionally, the process goes to step S322 to set the wafer lot to “hold release” and “non-production banked out” sequentially, or step S323 to set status to “hold release” and “bank move/bank in cancel” sequentially if the wafer lot is in non-production bank or in production bank. Thus, the MES follows standard procedural steps to release the wafer lot.

Subsequent to release, the process proceeds to step S331 to create a floating process flow and assigns the wafer lot to the flow by issuing flow instructions to the MES. The floating process flow includes a sorter operation step, such as slot mapping, carrier exchange, wafer lot combination, or splits, with relevant sorting recipes. The MES follows standard procedural steps to create the floating process flow and assigns the wafer lot to the flow. The tool dispatch rule is applied according to specific sorter constraints to determine the target wafer sorter 11. In step S332, the MES starts the transport system 12 to transport the wafer lot to the target wafer sorter, and the wafer sorter 11 to perform the sorter operation based on automated sorting recipe instructions.

When sorting is complete, the process goes to step S341 to acquire the current status and corresponding hold/bank information of the wafer lot from the temporary file or table. The original hold/bank type of wafer lot is determined as in step S351 according to the current status. If the original wafer lot is on hold, the process goes to step S361 to set the wafer lot to “lot hold” by issuing the status setting instructions to the MES. In addition, the process goes to step S362 to set the wafer lot to “non-production banked in” and “lot hold” sequentially, or step S363 to set that to “bank move/bank in” and “hold lot” sequentially if the original wafer lot is in non-production bank or in production bank. The MES follows standard procedural steps to hold or bank the wafer lot. Finally, in step S371, the temporary file or table is removed from the storage device 131.

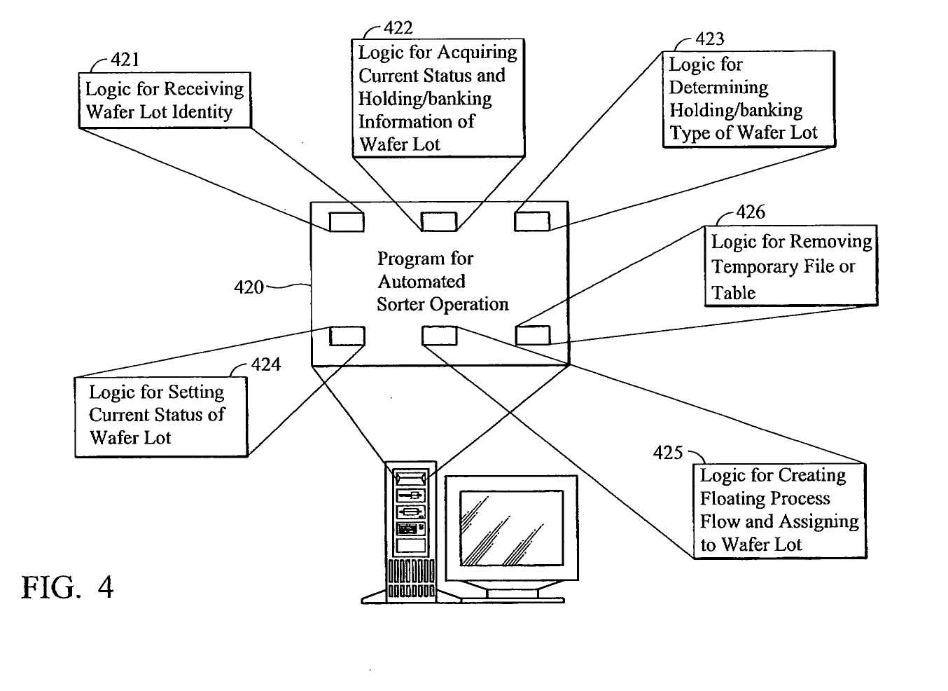

The invention additionally discloses a storage medium for storing a computer program providing the disclosed method of automated sorter operation, as shown in FIG. 4. The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system of automated sorter operation for held or banked wafer lots, comprising:
a storage device capable of storing a plurality of process records, each process record corresponding to a wafer lot and comprising an identity and a current status indicating if the wafer lot is on hold, in a production or in a non-production bank; and
a sorting module receiving a wafer lot identity, acquiring the current status corresponding to the wafer lot identity from the process record, issuing a first status setting instruction corresponding to the current status to a manufacturing execution system (MES) to release the wafer lot, issuing a flow instruction with sorting recipes directing the MES to perform a sorter operation, and issuing a second status setting instruction corresponding to the current status to the MES to hold or bank the wafer lot.

2. The system of claim 1 wherein the sorting module stores the current status into a temporary file or table, issues the second status setting instruction corresponding to the current status in the temporary file or table, and removes the temporary file or table after the sorter operation.

3. The system of claim 1 wherein the wafer lot identity is input by an operator or a computer system.

4. The system of claim 1 wherein the MES releases or holds/banks the wafer lot based on the first status setting instruction or the second status setting instruction respectively.

5. The system of claim 1 further comprising a wafer sorter performing sorter operations according to sorting recipes.

6. The system of claim 5 further comprising a transport system transporting the wafer lot to the wafer sorter.

7. The system of claim 6 wherein the MES applies a tool dispatch rule to determine the wafer sorter starts the transport system and the wafer sorter to perform the sorter operation using automated instructions.

8. The system of claim 1 wherein the sorter operation is slot mapping, carrier exchange, wafer lot combination or splits.

9. A method of automated sorter operation for held or banked wafer lots, the method comprising using a computer to perform the steps of:
receiving a wafer lot identity;
acquiring the current status corresponding to the wafer lot identity from a process record, wherein the process record corresponding to a wafer lot comprises the identity and the current status indicating if the wafer lot is on hold, in a production or in a non-production bank;
issuing a first status setting instruction corresponding to the current status to a manufacturing execution system (MES) to release the wafer lot;
issuing a flow instruction with sorting recipes to direct the MES to perform a sorter operation; and
issuing a second status setting instruction corresponding to the current status to the MES to hold or bank the wafer lot.

10. The method as claimed in claim 9 further comprising the steps of:
storing the current status into a temporary file or table;
issuing the second status setting instruction corresponding to the current status in the temporary file or table; and
removing the temporary file or table.

11. The method as claimed in claim 9 wherein the wafer lot identity is input by an operator or a computer system.

12. The method of claim 9 further comprising the steps of:
releasing the wafer lot based on the first status setting instruction by the MES; and
holding or banking the wafer lot based on the second status setting instruction by the MES.

13. The method of claim 9 further comprising a step of performing the sorter operation according to sorting recipes by the wafer sorter.

14. The method of claim 13 further comprising a step of transporting the wafer lot to the wafer sorter by the transport system.

15. The method of claim 14 further comprising the steps of:
applying a tool dispatch rule to determine the wafer sorter by the MES for the given wafer lot;
starting the transport system to transport the wafer lot to the wafer sorter by the MES using automated instructions; and
starting the wafer sorter to perform the sorter operation by the MES using automated instructions.

16. The method of claim 9 wherein the sorter operation is slot mapping, carrier exchange, wafer lot combination or splits.

17. A storage medium for storing a computer program which when executed performs a method of automated sorter operation for held or banked wafer lots, the method comprising the steps of:
receiving a wafer lot identity;
acquiring the current status corresponding to the wafer lot identity from a process record, wherein the process record corresponding to a wafer lot comprises the identity and the current status indicating if the wafer lot is on hold, in a production or in a non-production bank;
issuing a first status setting instruction corresponding to the current status to a manufacturing execution system (MES) to release the wafer lot;
issuing a flow instruction with sorting recipes to direct the MES to perform a sorter operation; and
issuing a second status setting instruction corresponding to the current status to the MES to hold or bank the wafer lot.

18. The storage medium of claim 17, wherein the method further comprises the steps of:
storing the current status into a temporary file or table;
issuing the second status setting instruction corresponding to the current status in the temporary file or table; and
removing the temporary file or table.

19. The storage medium of claim 17 wherein the wafer lot identity is input by an operator or a computer system.

20. The storage medium of claim 17 further comprising the steps of:
releasing the wafer lot based on the first status setting instruction by the MES; and
holding or banking the wafer lot based on the second status setting instruction by the MES.

21. The storage medium of claim 17, wherein the method further comprises a step of performing the sorter operation according to sorting recipes by the wafer sorter.

22. The storage medium of claim 21, wherein the method further comprises a step of transporting the wafer lot to the wafer sorter by the transport system.

23. The storage medium of claim 22, wherein the method further comprises the steps of:
applying a tool dispatch rule to determine the wafer sorter for the given wafer lot by the MES;
starting the transport system to transport the wafer lot to the wafer sorter by the MES using automated instructions; and
starting the wafer sorter to perform the sorter operation by the MES using automated instructions.

24. The storage medium of claim 17 wherein the sorter operation is slot mapping, carrier exchange, wafer lot combination or splits.
